(19) United States
(12) Patent Application Publication
(10) Pub. No.: US 2011/0147181 A1
(43) Pub. Date: Jun. 23, 2011

(54) THREE DIMENSIONAL GRAPHICS WITH CHANGING APPEARANCES

(75) Inventor: Michael R. Catlin, Holland, MI (US)

(73) Assignee: Johnson Controls Technology Company, Holland, MI (US)

(21) Appl. No.: 13/060,447

(22) PCT Filed: Aug. 26, 2009
(86) PCT No.: PCT/US2009/054980

§ 371 Date: Feb. 24, 2011

Related U.S. Application Data
(60) Provisional application No. 61/091,881, filed on Aug. 26, 2008.

(51) Int. Cl. H01H 9/16; H01J 9/00

(52) U.S. Cl. 200/311; 445/24

(57) ABSTRACT

The invention provides a button for an interior of a vehicle, a method of using a graphic on a button to indicate the current status or configuration of the button and/or a device the button controls, and a method of making a button with changing appearances, the button comprising a non-mechanical switch and the button comprising means for backlighting of at least two different colors, the button further comprising at least two band-pass filters (232, 234), the band-pass filters being configured to block one of the two different colors, while allowing the other to pass through, wherein a three dimensional appearance of the button is changed depending on which color is activated to provide backlighting to the button, wherein during a first status or configuration state of the button, one of the colors is activated to provide backlighting to a first portion (212) of the button and wherein during a second status or configuration state of the button, the other color is activated to provide backlighting to a second portion (214) of the button.

### CLAIM OF PRIORITY

The present application claims the benefit of the filing date of U.S. Provisional Application Ser. No. 61/091,881 (filed Aug. 26, 2008), and the entirety of the contents of this application being hereby expressly incorporated by reference.

### FIELD

This invention relates to three dimensional graphics with changing appearances.

### BACKGROUND

Buttons and control devices are often provided throughout the interior of a vehicle. Such buttons and control devices may be used to control, for example, a climate control system or an audio system of the vehicle or may provide controls for power windows or power door locks.

Some buttons or control devices may be identified by a two dimensional badge, logo or other type of indicia provided on or over the button or control device or nearby the button or control device. The indicia on, over or nearby the button or control device identifies the function of the button or control device or the device controlled by the button or control device to a user of the vehicle. In some cases, the indicia on, over or nearby the button or control device may be backlit.

However, known buttons usually comprise either at least one mechanical switch or do not provide an easily recognizable feedback about the actuation state to the user and usually require a complex structure and/or a complex assembly process and hence are costly and/or large and/or have a comparably high weight.

### SUMMARY

It is an object of the present invention to overcome or at least mitigate the disadvantages of the prior art. The present invention provides a button for an interior of a vehicle, a method of using a graphic on a button to indicate the current status or configuration of the button and/or a device the button controls, and a method of making a button with changing appearances.

The object of the present invention is achieved by a button for an interior of a vehicle, the button comprising a non-mechanical switch and the button comprising means for backlighting of at least two different colors, the button further comprising at least two band-pass filters, the band-pass filters being configured to block one of the two different colors, while allowing the other to pass through, wherein a three dimensional appearance of the button is changed depending on which color is activated to provide backlighting to the button, wherein during a first status or configuration state of the button, one of the colors is activated (i.e. the backlighting of that color is activated) to provide backlighting to a first portion of the button and wherein during a second status or configuration state of the button, the other color is activated (i.e. the backlighting of that color is activated) to provide backlighting to a second portion of the button.

It is thereby advantageously possible to provide for an actuation possibility inside a vehicle without mechanically moveable parts with respect to the switch of the button and still provide the possibility that a user of the button easily recognizes the actuation state of the button and/or of the device controlled by the button.

The possibility to actuate most preferably refers to an electrically controlled and/or electrically displayed function of the vehicle, e.g. the state of a climate control system or an audio system of the vehicle or controls for power windows or power door locks or power seats. The switch is designed to control such a function of the vehicle and the backlighting of the button/the button face is designed to show or display the actuation state of such a function, i.e. if a change occurs in the activation state of the vehicle function associated with a peculiar switch and a particular button, then the backlighting of that button is changed (i.e. a different color is activated within the button) to show (by means of the changed three dimensional graphics then visible on the button face) the changed status of that vehicle function.

In the context of the present invention, the term “non-mechanical” or “non-mechanical switch” means a switch that does not have mechanically moveable parts to be actuated by a user in terms of an important relative movement of two parts of the switch. This does not mean that there is no mechanical movement at all especially with regard to very small movements, e.g. in a range of less than 100 μm. Such small relative movements could occur, e.g. if the force of a users finger is detected by means of a capacitive element and the force of the user's finger would slightly move or at least partly displace an electrode of that capacitive element with respect to another electrode.

An embodiment of the present invention relates to a button for an interior of a vehicle that utilizes a capacitive or field effect switch and includes backlighting of at least two different colors and at least two different band-pass filters that are each configured to block one of the two different colored backlighting, while allowing the other to pass through. The backlighting is usable to change the three dimensional appearance of the button in response to a current status or configuration of the button and/or the device that the button controls by activating one of the colored backlights during a first status or configuration state to provide backlighting to a first portion of the button and activating the other colored backlight during a second status or configuration state to provide backlighting to a second portion of the button.

According to a preferred embodiment of the present invention, the means for backlighting comprise at least a first light source capable of emitting light of a first color and a second light source capable of emitting light of a second color, the band-pass filters comprising at least a first band-pass filter and a second band-pass filter, wherein the first band-pass filter blocks the light of the first color and is transmissive to the light of the second color, and wherein the second band-pass filter blocks the light of the second color and is transmissive to the light of the first color.

Thereby, it is advantageously possible to use, e.g. light emitting diodes (LED) as light sources for backlighting of the button or the button face.

According to a further preferred embodiment of the present invention, the button provides the three dimensional appearance on a flat surface or substrate.

The printing process and/or the substrate of the button face and/or of the band-pass filters may include a three dimensional component, but the end product is substantially two-dimensional or flat in relation to the image of the three dimensional appearance provided. This means that according to the present invention, the three dimensional appearance of the image is not necessarily related to a three dimensional shape of the end product, i.e. of the button face and/or band-pass filters.

According to still a further preferred embodiment of the present invention, the button has a button face, wherein the button face has a three dimensional logo, wherein the three dimensional logo provides a first visual appearance in the first portion of the button face during the first status or configuration state of the button, and wherein the three dimensional logo provides a second visual appearance in the second portion of the button face during the second status or configuration state of the button.

This provides the possibility to a user of the button inside vehicle to clearly and easily view the status or configuration state of the button by means of the three dimensional logo visible on the button face.

According to a very preferred embodiment of the present invention, the non-mechanical switch comprises any non-mechanical means for changing the status of any system in the vehicle (hereinafter also referred to as “vehicle system”) and which also changes the visual status of the button according to the present invention relating to the vehicle system to illustrate the present status of the vehicle system. Especially, the switch can be provided as one out of a capacitive switch, a field effect switch, a near field switch, or an inductive switch, and wherein the status or configuration state of the button is changed by actuating the non-mechanical switch.

Thereby, it is advantageously possible to provide a possibility for a vehicle user to actuate the button and/or a device inside the vehicle controlled by the button in an easy and very intuitive manner.

Furthermore according to the present invention, the visual appearance of the three dimensional logo comprises an image and/or a numeral and/or a word and/or a design and/or a pattern and/or a flip switch and/or a push button appearance.

Thereby, a multitude of different possibilities for the appearance of the button can be provided.

The invention further relates to a method of using a graphic on a button to indicate the current status or configuration of the button and/or a device the button controls, the button comprising a non-mechanical switch and the button comprising means for backlighting of at least two different colors, the button further comprising at least two band-pass filters, the band-pass filters being configured to block one of the two different colors, while allowing the other to pass through, wherein a three dimensional appearance of the button is changed depending on which color is activated to provide backlighting to the button, wherein during a first status or configuration state of the button, one of the colors is activated (i.e. the backlighting of that color is activated) to provide backlighting to a first portion of the button and wherein during a second status or configuration state of the button, the other color is activated to provide backlighting to a second portion of the button, wherein an actuation of the non-mechanical switch changes the status or configuration state of the button.

Thereby, it is advantageously possible to provide a possibility for a vehicle user to actuate a button and/or a device inside the vehicle in an easy and very intuitive manner.

According to the present invention, it is very much preferred that the non-mechanical switch is actuated by means of touching the button and/or by approaching a part of a user's body to the button.

It is thereby advantageously possible to actuate the button in a very easy manner.

Another embodiment of the present invention relates to a method of using a graphic on a button to indicate the current status or configuration of the button and/or the device the button controls. The button is provided with backlighting of a first color when the button and/or the device controlled by the button are in a first status or configuration state. The button is provided with backlighting of a second color when the button and/or the device controlled by the button are in a second status or configuration state. A first band-pass filter selectively blocks portions of the light from the first color backlighting and a second band-pass filter selectively blocks portions of the light from the second color backlighting, such that the button has different appearances under each lighting configuration.

The invention further relates to a method of making a button with changing appearances, the button comprising a non-mechanical switch and the button comprising means for backlighting of at least two different colors, the button further comprising at least two band-pass filters, the method comprising the step of:

configuring the band-pass filters to block one of the two different colors, while allowing the other to pass through, wherein a three dimensional appearance of the button is changed depending on which color is activated to provide backlighting to the button, wherein during a first status or configuration state of the button, one of the colors is activated (i.e. the backlighting of that color is activated) to provide backlighting to a first portion of the button and wherein during a second status or configuration state of the button, the other color is activated to provide backlighting to a second portion of the button.

Thereby, it is advantageously possible to provide a production possibility for a button which is comparably easy to manufacture and/or to assemble.

Another embodiment of the present invention relates to a method of making a button with changing appearances. The button is provided with first and second backlights, which are typically of different colors, and first and second band-pass filters. The first band-pass filter blocks light from the first backlight but not the second backlight, while the second band-pass filter blocks light from the second backlight but not the first backlight. The first and second band-pass filters selectively cover different portions of the button such that when the first backlight is active, a first portion of the button is backlit and when the second backlight is active, a second portion of the button is backlit. The first backlight is activated in response to a first status or configuration of the button or the device controlled by the button and the second backlight is activated in response to a second status or configuration of the button or the device controlled by the button.

These and other features and advantages of various exemplary embodiments of systems and methods according to this invention are described in, or are apparent from, the following detailed descriptions of various exemplary embodiments of various devices, structures and/or methods according to this invention.

### DRAWINGS

Various exemplary embodiments of the systems and methods according to this invention will be described in detail, with reference to the following figures, wherein:

FIG. 1 is a front plan view of a first exemplary embodiment of a button including a three-dimensional logo in a first backlight configuration;

FIG. 2 is a front plan view of the button of FIG. 1 with the three-dimensional logo in a second backlight configuration;

FIG. 3 is a schematic exploded view of the first exemplary embodiment of a button;

FIG. 4 is a schematic front plan view of a second exemplary embodiment of a button, the button in a first backlight configuration;

FIG. 5 is a schematic front plan view of the second exemplary embodiment of a button, the button in a second backlight configuration;

FIG. 6 is a schematic front plan view of a third exemplary embodiment of a button, the button in a first backlight configuration; and

FIG. 7 is a schematic front plan view of the third exemplary embodiment of a button, the button in a second backlight configuration.

### DESCRIPTION

It should be appreciated that, for the purposes of this disclosure, the term “three-dimensional printing” refers to a process of printing or otherwise providing an image with a three-dimensional appearance on a flat surface or substrate. The printing process and/or the substrate may include a three-dimensional component, but the end product is substantially two-dimensional in relation to the image provided. That is, the three-dimensional appearance of the image provided is not necessarily related to the three dimensional shape of the end product.

Likewise, for the purposes of this disclosure, the term “three-dimensional logo” refers to a logo that is provided according to the above-outlined “three-dimensional printing” process. As such, a “three-dimensional logo” is a logo or indicia provided on a substrate wherein the logo has a three-dimensional appearance that is not necessarily related to the three-dimensional shape of the substrate.

It should be appreciated that the above-outlined “three-dimensional logo” at least has a three-dimensional appearance. As such, the “three-dimensional logo” need not be physically three-dimensional and may be provided on a single planar surface. In various exemplary embodiments, the “three-dimensional logo” is physically three-dimensional and/or is provided across multiple planar surfaces.

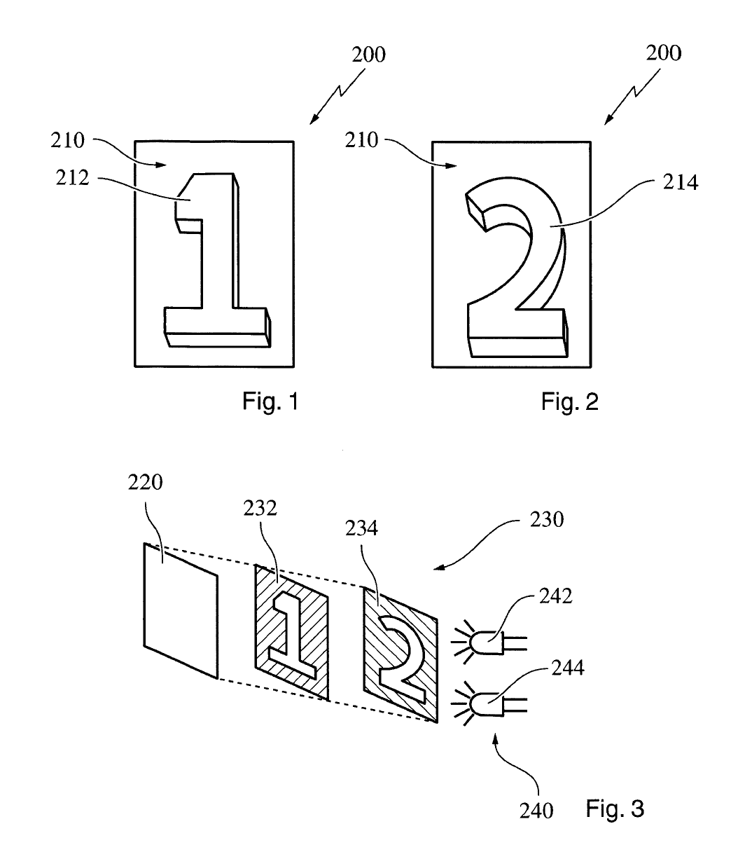

FIGS. 1 and 2 show a first exemplary embodiment of a button face 200. The button face 200 has a three-dimensional logo 210. The three-dimensional logo 201 may be provided by any known or later-developed three-dimensional printing process and may be provided on an insert at any suitable location within the interior of the vehicle (e.g., a door panel, a center console, a front dash, an overhead console, etc.) or even on the exterior of the vehicle. Likewise, the three-dimensional logo 210 may be provided directly on or in any desired component with or without the use of an insert. Additionally, the three-dimensional logo 210 may include images, words, designs, patterns or any other desired two-dimensional or three-dimensional visual appearance(s) or effect(s).

FIG. 1 shows the first exemplary embodiment of the button face 200 with the three-dimensional logo 210 in a first configuration. In the configuration shown in FIG. 1, the button face 200 is backlit with a first color, illuminating a first portion 212 of the three-dimensional logo 210. FIG. 2 shows the button face 200 in a second configuration. In the configuration shown in FIG. 2, the button face 200 is backlit with a second color, illuminating a second portion 214 of the three dimensional logo 210.

FIG. 3 shows an exploded view of the first exemplary embodiment of the button face 200. As shown in FIG. 3, the button face 200 has a front surface 220, which includes the three-dimensional logo 210 (not shown), band-pass filters 230 and light sources 240. In the exemplary embodiment shown in FIG. 3, the band-pass filters 230 include a first band-pass filter 232 and a second band-pass filter 234. Likewise, the light sources include a first light source 242 and a second light source 244.

It should be appreciated that in various exemplary embodiments, the button face 200 can include more than two light sources and/or more than two band-pass filters. In various other exemplary embodiments, the button face 200 may include a single light source and/or a single band-pass filter. In various exemplary embodiments, a single light source is capable of providing light of at least two different colors or wavelengths. In the exemplary embodiment shown in FIG. 3, the first light source 242 provides light of a first color or wavelength, while the second light source 244 provides light of a second color or wavelength.

The activation of a color or the activation of the backlighting of that color means especially, that the corresponding light source is activated.

Each of the first and second band-pass filters 232 and 234 is transmissive to at least one of the colors or wavelengths provided by the first and second light sources 242 and 244, while blocking at least one other color or wavelength provided by the first and second light sources 242 and 244. For example, in the exemplary embodiment shown in FIG. 3, the first band-pass filter 232 blocks the light provided by the first light source 242 and is transmissive to the light provided by the second light source 244, while the second band-pass filter 234 blocks the light provided by the second light source 244 and is transmissive to the light provided by the first light source 240.

As such, when the first light source 242 is active, providing light of a first color or wavelength, the first band-pass filter 232 will block the light wherever the first band-pass filter 232 is present, while the second band-pass filter 234 will allow all of the light to pass through, creating a first stenciled backlight in the shape of the first band-pass filter 232. Thus, the first portion 212 of the button face 200, which corresponds to the shape of the first stenciled backlight, will be backlit (e.g., the portion not covered by the first band pass filter 232).

Likewise, when the second light source 244 is active, providing light of a second color or wavelength, the second band-pass filter 234 will block the light wherever the second band-pass filter 234 is present, while the first band-pass filter 232 will allow all of the light to pass through, creating a second stenciled backlight in the shape of the second band-pass filter 234. Thus, the second portion 214 of the button face 200, which corresponds to the shape of the second stenciled backlight, will be backlit (e.g., the portion not covered by the second band pass filter 234).

The first and second band-pass filters 232 and 234 are generally shaped so that they block off different portions or patterns 212 and 214, respectively, of the front surface 220 and the three-dimensional logo 210. In this way, when the first light source 242 is active, the first portion 212 of the three-dimensional logo 210 is backlit and visible. Likewise, when the second light source 244 is active, the second portion 214 of the three-dimensional logo 210 is backlit and visible.

It should be appreciated that, while the three-dimensional logo 210 and the designs of the first and second band-pass filters 232 and 234 are shown as simple designs in FIGS. 1-3, namely the shape of the numerals “1” and “2”, any design, including complex overlapping shapes requiring multiple light sources and/or band-pass filters, is possible. Likewise, although it would appear that the shape of the band-pass filters 232 and 234 alone creates the shape of the three-dimensional logo 210, in fact, the combination of the first and second band-pass filters 232 and 234, as well as the first and second light sources 242 and 244 selectively illuminates different portions of the three-dimensional logo 210. In general, the shape of the band-pass filters 230 does not need to be related to the actual appearance of the three-dimensional logo 210, as each one of the band pass filters 230 simply blocks off or reveals a different portion of the three-dimensional logo 210.

Incorporating a non-mechanical switch (e.g., a capacitive switch, an inductive switch, a field effect switch, and/or any other known or later developed non-mechanical switch) with the button face 200 may provide a switch with changing indicia. The changing indicia can be used to illustrate a changing state of the non-mechanical switch that is incorporated with the button face 200, or the device controlled by the non-mechanical switch. For example, the first portion 212 of the three-dimensional logo 210 may resemble a “popped out” or “non-depressed” button, while the second portion 214 of the three-dimensional logo 210 may resemble a “pushed in” or “depressed” button. As such, the first light source 242 may be active when the device controlled by the non-mechanical switch is inactive, giving the appearance of a non-depressed button. When the non-mechanical switch and the button face 200 are pushed or touched to activate the device controlled by the non-mechanical switch, the second light source 244 is activated and the first light source 242 is deactivated, giving the appearance of a depressed button.

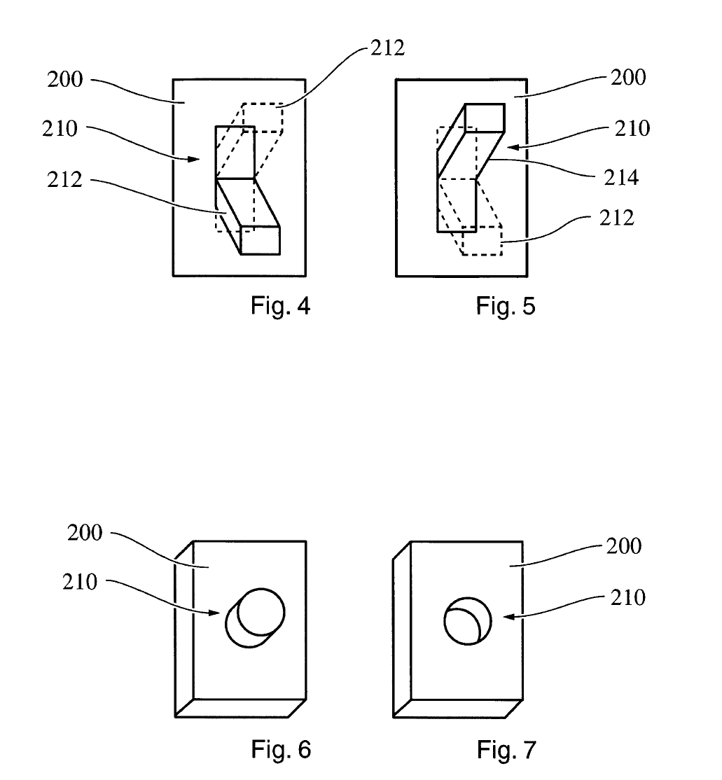

FIGS. 4-7 show exemplary embodiments of the button face 200 with various exemplary embodiments of the three-dimensional logo 210 that simulate various switches in different states. As shown in FIGS. 4 and 5, the three-dimensional logo 210 may simulate a flip switch similar to a common, known light switch. FIG. 4 shows the first portion 212 of the three-dimensional logo 210 illuminated, giving the appearance of a flip switch in an up position. FIG. 5 shows the second portion 214 of the three-dimensional logo 210 illuminated, giving the appearance of a flip switch in a down position. In both FIGS. 4 and 5, the non-illuminated portions of the three-dimensional logo (e.g., the second portion 214 in FIG. 4 and the first portion 212 in FIG. 5) are shown in phantom lines.

The three-dimensional logo 210 shown in FIGS. 4 and 5 may be particularly useful with field effect or other near field switches and may simulate a light switch style control in a two-dimensional switch. In such an embodiment, a user may move his or her hand past the button face 200 to “flip the switch” and activate/deactivate the device controlled by the switch. As the device is activated/deactivated, the first and second portions 212 and 214 of the three-dimensional logo are alternatively illuminated and not illuminated with one of the first and second portions 212 and 214 corresponding to, and being illuminated during, an activated state of the device controlled by the switch, and the other one of the first and second portions 212 and 214 corresponding to, and being illuminated during, a deactivated state of the device controlled by the switch.

As outlined above, the unlit portions of the three-dimensional logo 210 are shown in phantom lines in FIGS. 4 and 5. These lines show the two portions 212 and 214 that are alternatively lit or unlit. It should be appreciated that the unlit portion of the three-dimensional logo 210 (e.g., the second portion 214 when the first light source 242 is active and the first portion 212 when the second light source 244 is active) may or may not be visible. In general, the unlit portion 212 or 214 of the three-dimensional logo 210 will at least be less visible or less prominent than the lit portion (e.g., the first portion 212 when the first light source 242 is active and the second portion 214 when the second light source 244 is active).

Similarly, FIGS. 6 and 7 show a three-dimensional logo 210 that simulates a push button. FIG. 6 shows the push button extended, while FIG. 7 shows the push button depressed. The three-dimensional logo 210 shown in FIGS. 6 and 7 may be particularly useful with a touch activated button. As outlined above, such an embodiment can react to being pressed by appearing “pushed in” or “popped out”.

It should be appreciated that the above-described button may not be physically depressible. By having the appearance that the button is depressed it is meant that the logo on the front face of the button has a three-dimensional appearance that resembles a mechanical button that has been depressed. Likewise, a non-depressed appearance has an appearance that resembles a mechanical button that has not been depressed. However, it is possible to incorporate a depressible switch with the above-described button face to provide a depressible button according to this invention.

It should be appreciated that, although the three-dimensional logo 210 shown in FIGS. 1-7 uses simple perspective to create a three-dimensional appearance, any suitable known or later-developed technique for creating a three-dimensional appearance on a two-dimensional object may be used. In various exemplary embodiments, more complex techniques (e.g., lighting, shading, etc.) may be used, at least in part, to create a three-dimensional appearance of the three-dimensional logo 210.

For the purposes of this disclosure, the term “coupled” means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members to the two members and any additional intermediate members being attached to one another. Such joining may be permanent in nature or alternatively may be removable or releasable in nature.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. Button for an interior of a vehicle, the button comprising a non-mechanical switch and the button comprising means for backlighting of at least two different colors, the button further comprising at least two band-pass filters, the band-pass filters being configured to block one of the two different colors, while allowing the other to pass through, wherein a three dimensional appearance of the button is changed depending on which color is activated to provide backlighting to the button, wherein during a first status or configuration state of the button, one of the colors is activated to provide backlighting to a first portion of the button and wherein during a second status or configuration state of the button, the other color is activated to provide backlighting to a second portion of the button.

2. Button according to claim 1, wherein the means for backlighting comprise at least a first light source capable of emitting light of a first color and a second light source capable of emitting light of a second color, the band-pass filters comprising at least a first band-pass filter and a second band-pass filter, wherein the first band-pass filter blocks the light of the first color and is transmissive to the light of the second color, and wherein the second band-pass filter blocks the light of the second color and is transmissive to the light of the first color.

3. Button according to claim 1, wherein the button provides the three dimensional appearance on a flat surface or substrate.

4. Button according to claim 1, wherein the button has a button face, wherein the button face has a three dimensional logo, wherein the three dimensional logo provides a first visual appearance in the first portion of the button face during the first status or configuration state of the button, and wherein the three dimensional logo provides a second visual appearance in the second portion of the button face during the second status or configuration state of the button.

5. Button according to claim 1, wherein the non-mechanical switch comprises one out of a capacitive switch, a field effect switch, a near field switch, or an inductive switch, and wherein the status or configuration state of the button is changed by actuating the non-mechanical switch.

6. Button according to claim 1, wherein the visual appearance of the three dimensional logo comprises an image and/or a numeral and/or a word and/or a design and/or a pattern.

7. Button according to claim 1, wherein the visual appearance of the three dimensional logo comprise a flip switch and/or a push button.

8. Method of using a graphic on a button to indicate the current status or configuration of the button and/or a device the button controls, the button comprising a non-mechanical switch and the button comprising means for backlighting of at least two different colors, the button further comprising at least two band-pass filters, the band-pass filters being configured to block one of the two different colors, while allowing the other to pass through, wherein a three dimensional appearance of the button is changed depending on which color is activated to provide backlighting to the button, wherein during a first status or configuration state of the button, one of the colors is activated to provide backlighting to a first portion of the button and wherein during a second status or configuration state of the button, the other color is activated to provide backlighting to a second portion of the button, wherein an actuation of the non-mechanical switch changes the status or configuration state of the button.

9. Method according to claim 8, wherein the non-mechanical switch is actuated by means of touching the button and/or by approaching a part of a user's body to the button.

10. Method of making a button with changing appearances, the button comprising a non-mechanical switch and the button comprising means for backlighting of at least two different colors, the button further comprising at least two band-pass filters, the method comprising the step of:
configuring the band-pass filters to block one of the two different colors, while allowing the other to pass through, wherein a three dimensional appearance of the button is changed depending on which color is activated to provide backlighting to the button, wherein during a first status or configuration state of the button, one of the colors is activated to provide backlighting to a first portion of the button and wherein during a second status or configuration state of the button, the other color is activated to provide backlighting to a second portion of the button.
